(19) United States
(12) Patent Application Publication
(10) Pub. No.: US 2008/0005722 A1
(43) Pub. Date: Jan. 3, 2008

(54) Compiling device, compiling method and recording medium

(76) Inventor: Hidenori Matsuzaki, Kawasaki-shi (JP)

Correspondence Address: SPRINKLE IP LAW GROUP, 1301 W. 25TH STREET, SUITE 408, AUSTIN, TX, 78705, US

(21) Appl. No.: 11/476,501

(22) Filed: Jun. 28, 2006

(51) Int. Cl. G06F 9/44

(52) U.S. Cl. 717/122

(57) ABSTRACT

A compiling device according to an example of the invention comprises a unit which allocates a code to a pseudo register having an infinite storage area, a unit which judges whether or not a register live range for the pseudo register is of a scalar used type or an SIMD used type, a unit which secures an SIMD physical register for spilling, in a case where it is judged that the register live range can not be allocated to the physical register and that the register live range is of the scalar used type, and a unit which allocates a part or all of the code of the register live range to the SIMD physical register for spilling, allocates a remaining code of the register live range to the physical register, and allocates, to the physical register, a register spilling code instead of a part or all of the code of the register live range, in a case where the SIMD physical register for spilling is secured.

### BACKGROUND OF THE INVENTION

In lines 18 to 35 of a left portion of page 3 of Document 1 (Jpn. Pat. Appln. KOKAI Publication No. 6-139069), an instruction consists of an address field and a data size field to read a portion of register data.

In lines 17 to 37 of a left portion of page 3 of Document 2 (Jpn. Pat. Appln. KOKAI Publication No. 9-91151), a compiler and a processor utilize registers which cannot be accessed by ISA to reduce memory accesses caused by shortage of registers which are ISA accessible.

### BRIEF SUMMARY OF THE INVENTION

A compiling device according to an example of the invention comprises a first allocating unit which allocates a code to a pseudo register having an infinite storage area; a first judgment unit which judges whether or not a register live range for the pseudo register is of a scalar used type or an SIMD used type; a second judgment unit which judges whether or not the register live range is able to be allocated to a physical register; a second allocating unit which allocates the register live range to the physical register, in a case where it is judged that the register live range is able to be allocated to the physical register; a securing unit which secures an SIMD physical register for spilling, in a case where it is judged that the register live range is not able to be allocated to the physical register and that the register live range is of the scalar used type; and a third allocating unit which allocates a part or all of the code of the register live range to the SIMD physical register for spilling, allocates a remaining code of the register live range to the physical register, and allocates, to the physical register, a register spilling code instead of a part or all of the code of the register live range, in a case where the securing unit secures the SIMD physical register for spilling.

### BRIEF DESCRIPTION OF THE SEVERAL VIEWS OF THE DRAWING

FIG. 1 is a block diagram showing an example of a compiling device of the first embodiment.

FIG. 2 is a flowchart showing an example of a register allocating algorithm by the compiling device of the first embodiment.

FIG. 3 is a block diagram showing an example of an optimization compiling device in the second embodiment.

FIG. 4 is a flowchart showing an example of register allocation processing by a graph coloring method of the compiling device in the second embodiment.

### DETAILED DESCRIPTION OF THE INVENTION

Embodiments of the present invention will be described hereinafter with reference to the drawings.

### First Embodiment

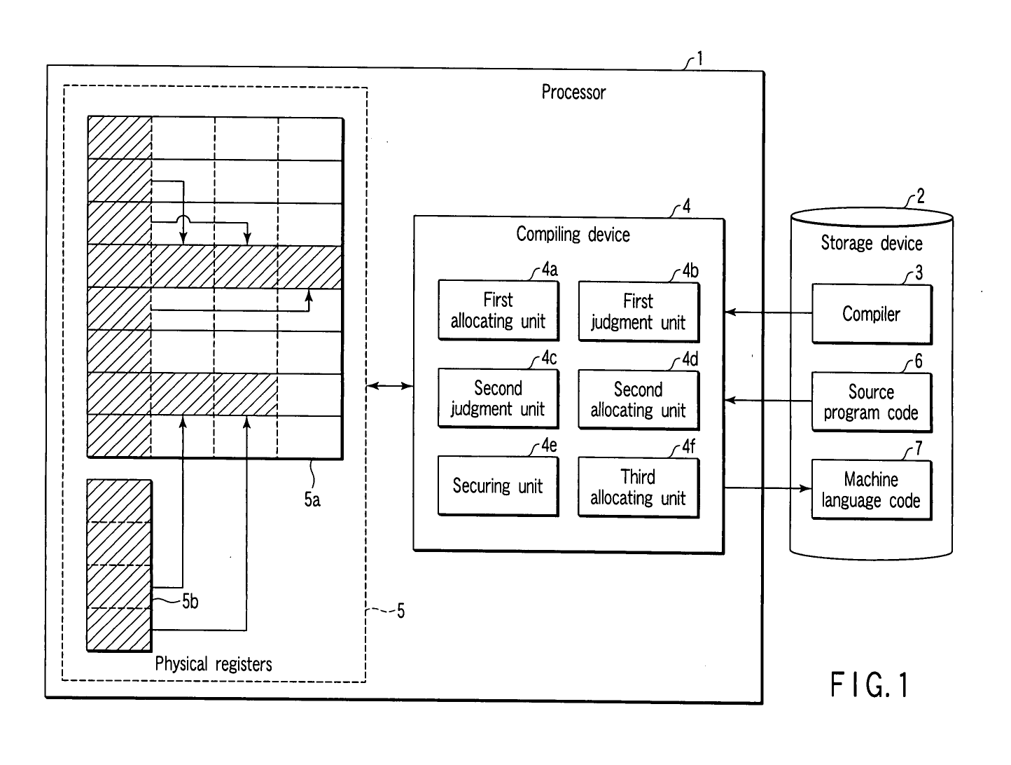

FIG. 1 is a block diagram showing an example of a compiling device of the present embodiment.

A processor 1 reads and executes a compiler 3 stored in a storage device 2 to function as a compiling device 4. The processor 1 comprises physical registers 5 including a single instruction multiple data (SIMD) physical register 5a and a scalar physical register 5b.

The compiling device 4 converts a source program code 6 stored in the storage device 2 into a machine language code 7, and the machine language code 7 is allocated to the physical registers 5 by the compiling device 4.

In the present embodiment, in a case where the compiling device 4 allocates a scalar instruction onto the SIMD physical register 5a, an unused area of the SIMD physical register 5a is selected as a register spilling area by the compiling device 4.

The SIMD physical register 5a is, for example, a wide width register (i.e., width of 128 bits) capable of storing an SIMD instruction. The SIMD instruction is associated with a plurality of data, and a broad data storage area is required for the SIMD instruction.

A data storage area of the scalar instruction may be smaller than a data storage area of the SIMD instruction.

The processor 1 has a SIMD function which requires the SIMD physical register 5a. A code for the processor 1 comprises both of the scalar instruction which needs short width data and an SIMD instruction which needs wide width data.

In the compiling device 4, a register spilling code is inserted in the machine language code 7 as a compiling result, when the number or capacity of the physical registers 5 is not enough to be mapped.

The register spilling code comprises a store instruction and a load instruction to save and restore the data of the physical registers 5 which have to be spilled.

In the compiling of the compiling device 4, an area which does not affect other contents stored in the physical registers 5 is using as the register spilling area in a case where the scalar instruction is register-spilled.

The register spilling code can be improved to use the SIMD physical register 5a's unused area as the register spilling area, when an instruction set architecture (ISA) allows data to be moved between a general-purpose register (GPR) and a specific area of the SIMD physical register 5a or the GPR itself is the SIMD physical register 5a, and there is an instruction which moves a part of SIMD data into a specific area of another SIMD physical register without affecting other parts.

In the present embodiment, the compiling device 4 includes: a first allocating unit 4a; a first judgment unit 4b; a second judgment unit 4c; a second allocating unit 4d; a securing unit 4e; and a third allocating unit 4f.

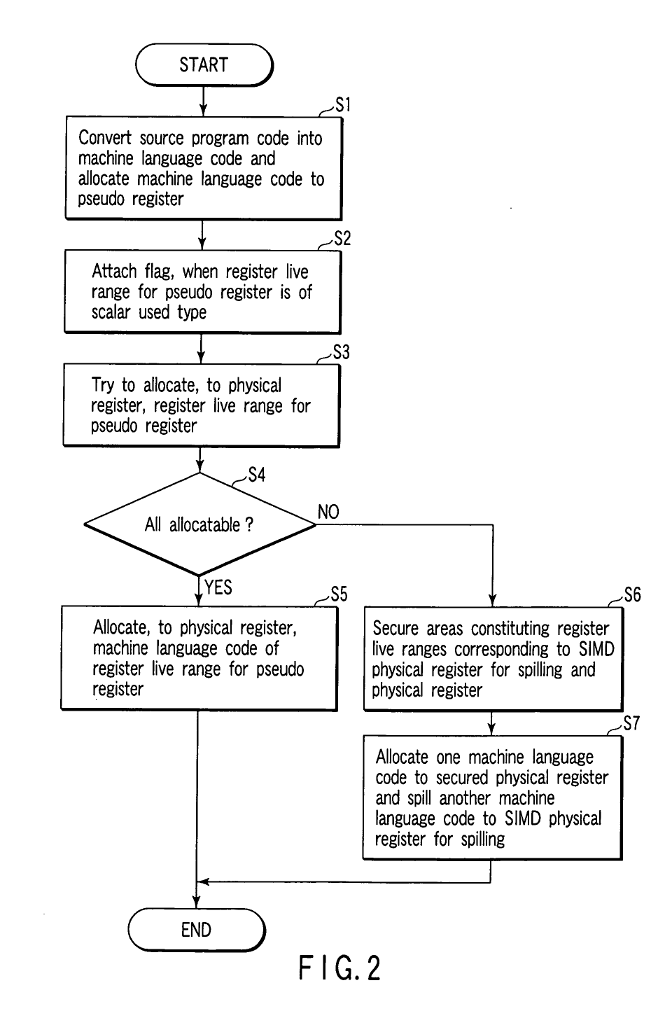

FIG. 2 is a flowchart showing an example of a register allocating algorithm by the compiling device 4 of the present embodiment.

In step S1, the first allocating unit 4a converts, into the machine language code 7, the source program code 6 described in a high-class programming language such as C language, and allocates the machine language code 7 to pseudo registers having infinite areas.

In step S2, the first judgment unit 4b calculates register live ranges (register used areas) for all pseudo registers, judges whether a type of each register live range corresponds to a scalar used type or an SIMD used type, and attaches a flag S to the register live range of pseudo register corresponding to the scalar used type.

In step S3, the second judgment unit 4c tries to allocate the register live ranges for the pseudo registers to the physical registers 5 by use of a graph coloring method.

In step S4, the second judgment unit 4c judges whether or not the register live ranges for all of the pseudo registers have been allocated to the physical register 5.

In step S5, the second allocating unit 4d allocates the machine language code 7 of the register live ranges for the pseudo registers to the physical registers 5, when the register live ranges for all of the pseudo registers are allocated to the physical registers 5. Moreover, register allocation processing ends.

In a case where there is a register live range for the pseudo register which cannot be allocated to the physical registers 5, for example, in a case where the number or capacity of the physical registers 5 is shorter than the number or capacity of the register live ranges for the pseudo registers, in step S6, the securing unit 4e secures an area constituting a register live range for the physical registers 5, and secures an area constituting a register live range for the SIMD physical register 5a for spilling.

In step S7, the third allocating unit 4f allocates a code to the secured area of physical registers 5, and spills a code of one of the register live ranges for the pseudo registers in the secured SIMD physical register 5a for spilling.

In the step S6, the register live range for the pseudo register flagged S has a priority to be selected as a spilled target register.

Within the register live ranges for the pseudo registers flagged S, a register live range for the pseudo register flagged S being less used and having a longer range is selected as the spilled target.

When a register live range of the pseudo register flagged S is selected to be spilled, and there is not a register available area in the SIMD physical register 5a for spilling, the third allocating unit 4f reserves a physical register to store data of the selected register live range for the pseudo register flagged S.

In the present embodiment described above, when the compiling device 4 is used, a register spilling can be realized so that a cache miss is not easily generated, and register spilling cost can be reduced.

Moreover, in the present embodiment, the SIMD physical register 5a can effectively be used by using the unused area of the SIMD physical register Sa as the register spilling area.

In the present embodiment, critical paths of code sequences can be reduced, and a code scheduling can be improved.

Furthermore, in the present embodiment, an execution speed of the compiling device 4 can be increased.

It is to be noted that in the step S4, a weight value of the register live range for the pseudo register flagged S may be increased, a weight value of the register live range for the pseudo register which is not flagged S may be decreased, and the register live range for the pseudo register being less used and having a longer range may be selected in consideration of the weight value.

### Second Embodiment

In a second embodiment, a modification of the compiling device of the first embodiment will be described in detail.

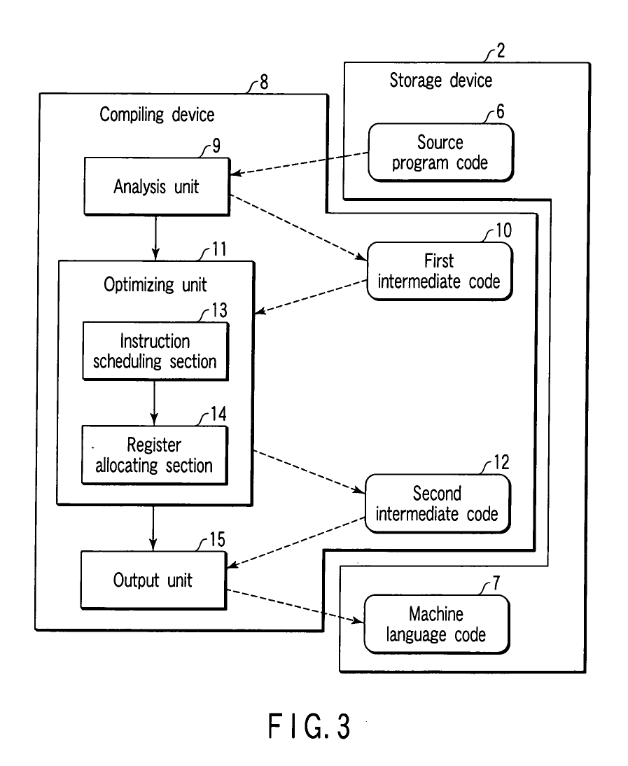

FIG. 3 is a block diagram showing an example of an optimization compiling device in the present embodiment.

A compiling device 8 inputs a source program code 6 stored in a storage device 2 and written in a high-class language. For example, a main storage device, a disc storage device or the like is used as the storage device 2.

An analysis unit 9 of the compiling device 8 executes lexical analysis processing, syntax analysis processing and the like for the input source program code 6, generates a first intermediate code 10, and stores the first intermediate code 10 in the storage device 2.

In the lexical analysis processing, a character string forming the input source program code 6 is analyzed, and divided every word.

For example, in the syntax analysis processing, it is judged whether or not words and phrases obtained by the lexical analysis processing are correct with reference to grammar of the high-class language. If there is a mistake, this mistake is notified, and execution is discontinued. When the words and phrases are correct, the first intermediate code 10 is generated as a syntax analysis result, and stored in the storage device 2.

An optimizing unit 11 subjects the first intermediate code 10 to optimization for speeding up the processing (optimization for increasing an execution speed in a case where a generated object program is executed by a processor), generates an optimized second intermediate code 12, and stores the optimized second intermediate code 12 in the storage device 2.

It is to be noted that in the optimizing unit 11 of the present embodiment, an instruction scheduling section 13 executes an instruction scheduling. Thereafter, a register allocating section 14 executes a register allocation and the like.

More specifically, the optimizing unit 11 performs, for example, flow analysis, data dependence analysis, instruction scheduling (instruction allocating), register allocating and the like.

In flow analysis processing, when the first intermediate code 10 is generated, a program flow is analyzed based on the first intermediate code 10.

In data dependence analysis processing, after the flow of the program is analyzed, a data dependence analysis for each instruction constituting the first intermediate code 10 is executed, a dependence graph is generated, and there is clarified, for example, a restriction on an instruction allocation execution order.

In instruction scheduling processing, based on the first intermediate code 10, a second intermediate code 12 is generated which is a state immediately before an object program and to which pseudo registers are allocated.

In register allocation processing, register allocation is performed to re-allocate the intermediate code generated by the instruction scheduling processing to physical registers 5 of a processor from the pseudo registers to which the intermediate code has been tentatively allocated by the instruction scheduling.

In the present embodiment, it is assumed that correspondences between pseudo registers and physical registers are registered in a register correspondence table.

An output unit 15 generates a machine language code 7 executable by the processor based on the optimized second intermediate code 12, and stores the machine language code 7 in the storage device 2. That is, the output unit 15 replaces, with the physical registers, the pseudo registers of the optimized second intermediate code 12 based on the register correspondence table, and outputs the machine language code 7.

It is to be noted that the first and second intermediate codes 10 and 12 are usually managed in the compiling device 8, and are not accessed from the outside.

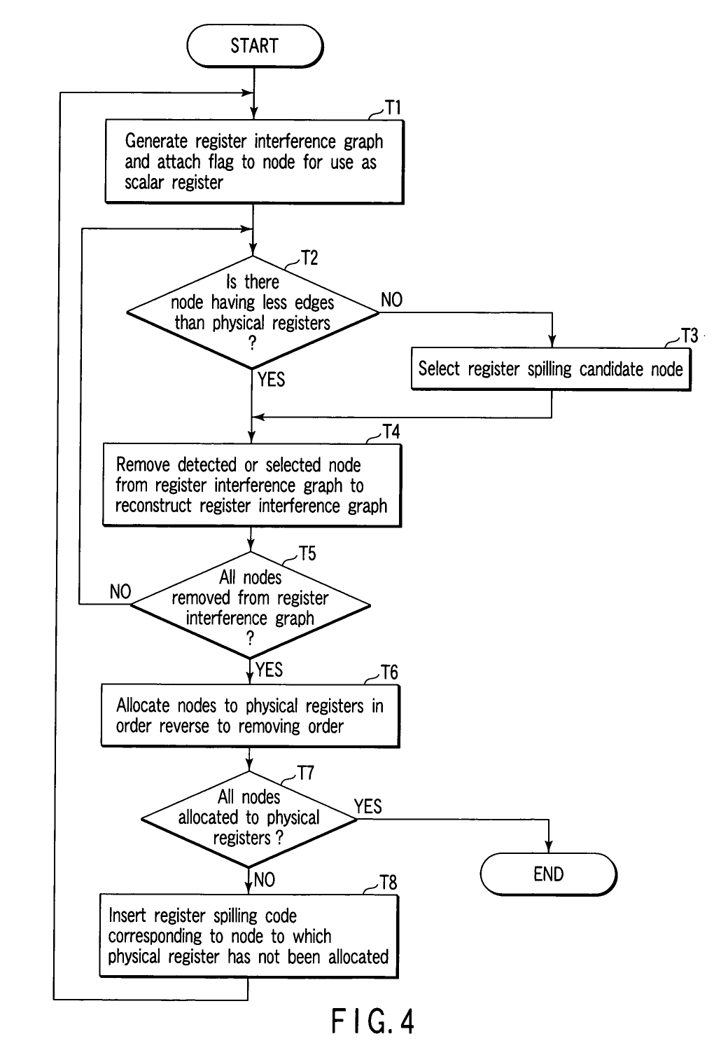

FIG. 4 is a flowchart showing an example of the register allocation processing by a graph coloring method of the compiling device 8 in the present embodiment.

In step T1, the register allocating section 14 generates a register interference graph, and attaches a flag S to a node for use as a scalar register so that it is possible to judge whether each node is used as a scalar register or an SIMD register.

Nodes of the register interference graph corresponds to pseudo registers. When an area for defining a value of a pseudo register is included in a live range of another pseudo register, the nodes corresponding to the pseudo registers are connected by an edge.

After generating the register interference graph in the step T1, a physical register allocation order for the nodes of the register interference graph is determined in steps T2 and T3.

In the step T2, among the nodes of the register interference graph, the register allocating section 14 detects a node having the number of the edges extending from the node (the number of other nodes adjacent to the node), the number is smaller than the number of allocatable physical registers.

When there is not any node having less adjacent nodes than the allocatable physical registers, in the step T3, the register allocating section 14 selects a node as a register spilling candidate, and the processing shifts to step T4.

When the register spilling candidate node is selected in the step T3, the node flagged S is preferentially selected. When there are a plurality of nodes flagged S, the register allocating section 14 selects the node from the nodes flagged S by use of a heuristic method.

It is to be noted that when the register spilling candidate node is heuristically selected, a desired weight may be applied to the node flagged S to be selected. In this case, even if the node flagged S exists, a pseudo register of a SIMD used type is selected, in a case where a weight of a node of the SIMD used type is larger than a weight of the node flagged S.

When the node is detected in the step T2, or after the step T3, in the step T4, the register allocating section 14 removes the detected or selected node from the register interference graph to reconstruct the register interference graph. Here, the reconstruction of the register interference graph means that there is removed, from the register interference graph, the detected or selected node and the edge brought into contact with the detected or selected node.

In step T5, the register allocating section 14 judges whether or not all nodes have been removed from the register interference graph.

When the node remains in the register interference graph, the processing returns to the step T2, and is repeated until the register interference graph becomes blank.

When all of the nodes are removed from the register interference graph, physical register allocation processing is next executed.

In step T6, the register allocating section 14 allocates the nodes to the physical registers in an order reverse to an order in which the nodes have been removed in the step T4. Here, when the physical register to be allocated to a node is not found, the physical registers are allocated to the next nodes without allocating any physical register to the node.

In step T7, the register allocating section 14 judges whether or not the physical registers have been allocated to all of the nodes.

When the physical registers are allocated to all of the nodes, the register allocation processing ends.

In a case where the node exists to which any physical register is not allocated, in step T8, the register allocating section 14 inserts a register spilling code for storing or reading in a memory (stacking area) for the node to which any physical register has not been allocated, and divides or shortens a register live range of the node to which any physical register has not been allocated. After executing the step T8, the processing returns to the step T1.

When the node flagged S is spilled in this step T8, a register spilling or restoring code for spilling or restoring data is inserted in an empty slot of the physical register secured for the spilling instead of inserting a node spilling or restoring code with respect to a memory.

Moreover, when the physical register for spilling is not secured, or the empty slot does not have a sufficient capacity, a new physical register for spilling is secured. Moreover, this secured physical register is excluded from allocatable physical register candidates in the steps T2 and T6.

The above embodiments are not limited to the above constitutions as such, and constituting elements can be modified and embodied without departing from the scope of the present invention in an implementing stage.

What is claimed is:

1. A compiling device comprising:
a first allocating unit which allocates a code to a pseudo register having an infinite storage area;
a first judgment unit which judges whether or not a register live range for the pseudo register is of a scalar used type or an SIMD used type;
a second judgment unit which judges whether or not the register live range is able to be allocated to a physical register;
a second allocating unit which allocates the register live range to the physical register, in a case where it is judged that the register live range is able to be allocated to the physical register;
a securing unit which secures an SIMD physical register for spilling, in a case where it is judged that the register live range is not able to be allocated to the physical register and that the register live range is of the scalar used type; and
a third allocating unit which allocates a part or all of the code of the register live range to the SIMD physical register for spilling, allocates a remaining code of the register live range to the physical register, and allocates, to the physical register, a register spilling code instead of a part or all of the code of the register live range, in a case where the securing unit secures the SIMD physical register for spilling.

2. The compiling device according to claim 1, wherein the first judgment unit attaches a flag to the register live range, in a case where the register live range is of the scalar used type, and
the securing unit secures the SIMD physical register for spilling, in a case where it is judged that the register live range is not able to be allocated to the physical register and the flag is attached to the register live range.

3. The compiling device according to claim 1, wherein the third allocating unit selects a portion of the register live range which has been judged to be of the scalar used type in preference to a portion of the register live range which has been judged to be of the SIMD used type, and allocates, to the SIMD physical register for spilling, the portion which has been judged to be of the scalar used type.

4. The compiling device according to claim 1, wherein the third allocating unit allocates, to the SIMD physical register for spilling, the portion which has been judged to be of the scalar used type, in a case where a weight value of the portion of the register live range which has been judged to be of the scalar used type is larger than a weight value of the portion of the register live range which has been judged to be of the SIMD used type.

5. The compiling device according to claim 1, wherein the third allocating unit allocates a part or all of the code of the register live range to an unused area of the SIMD physical register for spilling.

6. A compiling method comprising:
allocating a code to a pseudo register having an infinite storage area;
judging whether or not a register live range for the pseudo register is of a scalar used type or an SIMD used type;
judging whether or not the register live range is able to be allocated to a physical register;
allocating the register live range to the physical register, in a case where it is judged that the register live range is able to be allocated to the physical register;
securing an SIMD physical register for spilling, in a case where it is judged that the register live range is not able to be allocated to the physical register and that the register live range is of the scalar used type; and
allocating a part or all of the code of the register live range to the SIMD physical register for spilling, allocating a remaining code of the register live range to the physical register, and allocating, to the physical register, a register spilling code instead of a part or all of the code of the register live range, in a case where the SIMD physical register for spilling is secured.

7. The compiling method according to claim 6, wherein the method which attaches a flag to the register live range, in a case where the register live range is of the scalar used type, and
secures the SIMD physical register for spilling, in a case where it is judged that the register live range is not able to be allocated to the physical register and the flag is attached to the register live range.

8. The compiling method according to claim 6, wherein the method which selects a portion of the register live range which has been judged to be of the scalar used type in preference to a portion of the register live range which has been judged to be of the SIMD used type, and allocates, to the SIMD physical register for spilling, the portion which has been judged to be of the scalar used type.

9. The compiling method according to claim 6, wherein the method which allocates, to the SIMD physical register for spilling, the portion which has been judged to be of the scalar used type, in a case where a weight value of the portion of the register live range which has been judged to be of the scalar used type is larger than a weight value of the portion of the register live range which has been judged to be of the SIMD used type.

10. The compiling method according to claim 6, wherein the method which allocates a part or all of the code of the register live range to an unused area of the SIMD physical register for spilling.

11. A computer readable recording medium comprising:
a first allocating computer readable program code which allocates a code to a pseudo register having an infinite storage area;
a first judgment computer readable program code which judges whether or not a register live range for the pseudo register is of a scalar used type or an SIMD used type;
a second judgment computer readable program code which judges whether or not the register live range is able to be allocated to a physical register;
a second allocating computer readable program code which allocates the register live range to the physical register, in a case where it is judged that the register live range is able to be allocated to the physical register;
a securing computer readable program code which secures an SIMD physical register for spilling, in a case where it is judged that the register live range is not able to be allocated to the physical register and that the register live range is of the scalar used type; and
a third allocating computer readable program code which allocates a part or all of the code of the register live range to the SIMD physical register for spilling, allocates a remaining code of the register live range to the physical register, and allocates, to the physical register, a register spilling code instead of a part or all of the code of the register live range, in a case where the securing computer readable program code secures the SIMD physical register for spilling.

12. The computer readable recording medium according to claim 11, wherein the first judgment computer readable program code attaches a flag to the register live range, in a case where the register live range is of the scalar used type, and
the securing computer readable program code secures the SIMD physical register for spilling, in a case where it is judged that the register live range is not able to be allocated to the physical register and the flag is attached to the register live range.

13. The computer readable recording medium according to claim 11, wherein the third allocating computer readable program code selects a portion of the register live range which has been judged to be of the scalar used type in preference to a portion of the register live range which has been judged to be of the SIMD used type, and allocates, to the SIMD physical register for spilling, the portion which has been judged to be of the scalar used type.

14. The computer readable recording medium according to claim 11, wherein the third allocating computer readable program code allocates, to the SIMD physical register for spilling, the portion which has been judged to be of the scalar used type, in a case where a weight value of the portion of the register live range which has been judged to be of the scalar used type is larger than a weight value of the portion of the register live range which has been judged to be of the SIMD used type.

15. The computer readable recording medium according to claim 11, wherein the third allocating computer readable program code allocates a part or all of the code of the register live range to an unused area of the SIMD physical register for spilling.
